(19) United States
(12) Patent Application Publication
(10) Pub. No.: US 2023/0037329 A1
(43) Pub. Date: Feb. 9, 2023

(54) OPTICAL SYSTEMS AND METHODS FOR PREDICTING FIXATION DISTANCE

(71) Applicant: Meta Platforms Technologies, LLC, Menlo Park, CA (US)

(72) Inventors: Ian Erkelens, Kirkland, WA (US); Thomas Scott Murdison, Seattle, WA (US); Kevin James MacKenzie, Sammamish, WA (US)

(21) Appl. No.: 17/859,176

(22) Filed: Jul. 7, 2022

Related U.S. Application Data
(60) Provisional application No. 63/229,539, filed on Aug. 5, 2021.

(51) Int. Cl. G02B 27/01; G06F 3/01

(52) U.S. Cl. CPC G02B 27/0172; G06F 3/013; G02B 27/0179; G02B 2027/014; G02B 2027/0178; G02B 2027/0185

(57) ABSTRACT

Head-mounted display systems may include an eye-tracking subsystem and a fixation distance prediction subsystem. The eye-tracking subsystem may be configured to determine at least a gaze direction of a user's eyes and an eye movement speed of the user's eyes. The fixation distance prediction subsystem may be configured to predict, based on the eye movement speed and the gaze direction of the user's eyes, a fixation distance at which the user's eyes will become fixated prior to the user's eyes reaching a fixation state associated with the predicted fixation distance. Additional methods, systems, and devices are also disclosed.

### CROSS-REFERENCE TO RELATED APPLICATION

This application claims the benefit of U.S. Provisional Patent Application No. 63/229,539, titled “OPTICAL SYSTEMS AND METHODS FOR PREDICTING FIXATION DISTANCE,” filed 5 Aug. 2021, the entire disclosure of which is incorporated herein by reference.

### BRIEF DESCRIPTION OF DRAWINGS

The accompanying drawings illustrate a number of example embodiments and are a part of the specification. Together with the following description, these drawings demonstrate and explain various principles of the present disclosure.

FIG. 1A is a diagram illustrating the eye vergence, according to at least one embodiment of the present disclosure.

FIG. 1B is a plot illustrating an example response time that person's eyes verge and accommodate to focus on objects at a new distance, according to at least one embodiment of the present disclosure.

FIG. 2 is a block diagram illustrating a head-mounted optical system, according to at least one embodiment of the present disclosure.

FIG. 3 is a plot showing a relationship between peak velocity and response amplitude for a full convergence of eyes, according to at least one embodiment of the present disclosure.

FIGS. 4A-4C include three plots showing position, velocity, and acceleration of eye movements during a convergence action, according to at least one embodiment of the present disclosure.

FIG. 5 is a plot illustrating actual eye movement data and an overlaid model for coarse alignment responses of eyes, according to at least one embodiment of the present disclosure.

FIG. 6 is a plot showing a relationship between peak velocity and response amplitude for coarse convergence of eyes, according to at least one embodiment of the present disclosure.

FIG. 7 is a flow diagram illustrating a method of operating a head-mounted optical device, according to at least one embodiment of the present disclosure.

FIG. 8 is an illustration of example augmented-reality glasses that may be used in connection with embodiments of this disclosure.

FIG. 9 is an illustration of an example virtual-reality headset that may be used in connection with embodiments of this disclosure.

FIG. 10 an illustration of an example system that incorporates an eye-tracking subsystem capable of tracking a user's eye(s).

FIG. 11 is a more detailed illustration of various aspects of the eye-tracking subsystem illustrated in FIG. 10.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within this disclosure.

### DETAILED DESCRIPTION OF EXAMPLE EMBODIMENTS

Head-mounted displays (HMDs) are head-mounted devices that may include a near-eye display (NED) to present visual content to a user. The visual content may include stereoscopic images that cause the user to view the content as three-dimensional (3D). HMDs can be used for education, gaming, healthcare, social interactions, and a variety of other applications.

Some HMDs may be configured to change the visual content depending on where a user gazes. For example, a varifocal system may be used to adjust a focal distance of an optical element based on a user gaze direction and/or gaze depth. By way of another example, gaze-driven rendering (e.g., foveated rendering, rendered depth-of-field, etc.) is a concept in which the portion of the visual content where the user fixates is held in focus, while a portion of the visual content away from the user's fixation (e.g., content in the visual periphery or at a different perceived depth) is blurred. This technique mimics a person's real-world experience, since eyes naturally focus on an object in a center of the person's view and at a fixation distance, and other portions of the person's vision (e.g., peripheral vision, objects at a different depth) may be physically perceived as out-of-focus. Thus, gaze-driven rendering may result in a more immersive and realistic experience for the user. In addition, gaze-driven rendering can result in reduced computing requirements, since portions of the visual content away from the user's focus are not fully rendered at high definition. This can reduce a size and/or weight of an HMD. However, gaze-based rendering systems may experience system latency in adjusting the focus and blurring after tracking where the user's eyes are fixated. As latency increases, user experience may decrease in terms of image quality and/or comfort.

In another example, eye-tracking may enable the user to interact with the visual content by simply visually dwelling on a displayed object, scene, word, icon, or the like. This visual interaction may be used to replace or supplement traditional handheld controllers.

In yet another example, augmented-reality glasses are a type of HMD that displays content to a user in a see-through display. Determining where the user gazes, or will soon gaze, in a real-world environment in front of the user may enable an augmented-reality system to obtain information about what the user looks at and is attending to. Determining a focal distance of the user's eyes may be important to adjust the displayed content for comfort or context.

Determining where a user gazes may be accomplished with an eye-tracking system. As explained further below, eye-tracking systems may employ optical tracking, ultrasound tracking, or other types of tracking (e.g., electro-oculography (EOG), search coils, etc.) to determine the gaze direction of the user's eye. For example, a camera (e.g., a visible light camera and/or an infrared camera) or an ultrasound transceiver may be directed at the user's eye and may sense reflected light or sound to generate data indicative of where the user's pupil, iris, sclera, and/or cornea is located. A processor may use this sensor data to calculate the gaze direction.

When a person gazes at objects at different distances, the eyes move in opposite directions (e.g., inward or outward) to bring the objects into focus and to overlap images from each eye for stereoscopic vision. For example, the eyes will be oriented at a wider gaze angle to view objects that are far away and at a narrower gaze angle to view objects that are close. This process of the eyes moving in opposite directions is referred to as “vergence.”

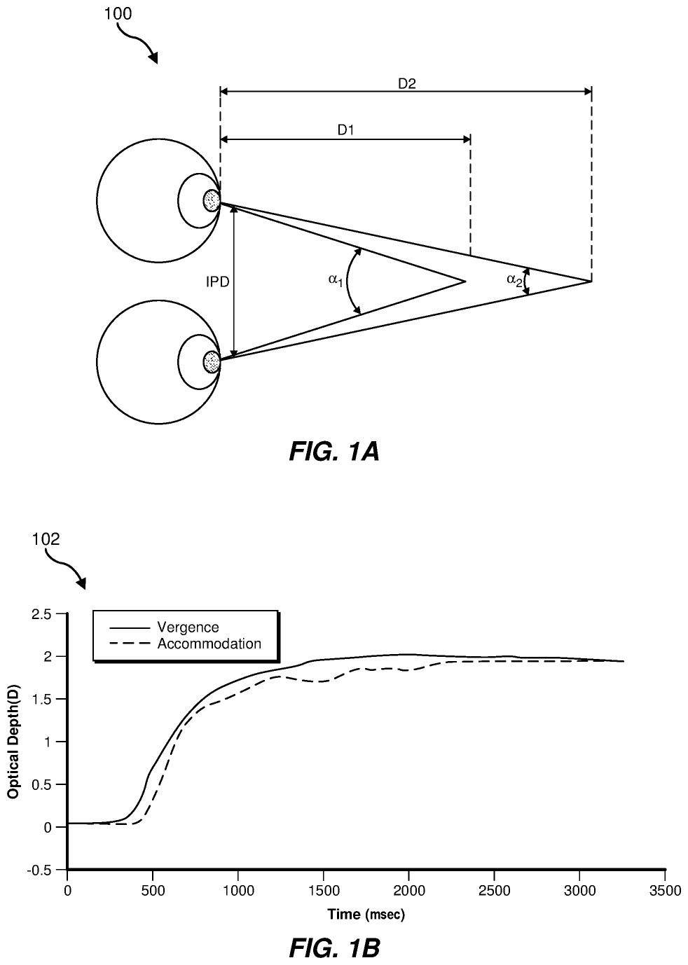

FIG. 1A is a diagram that illustrates the concept of vergence. A person may gaze at a first, relatively close object at a first fixation distance D1 from the person's eyes 100 and at a second, relatively distant object at a second fixation distance D2. A vergence angle may be defined as an angle between the respective gaze directions of the person's eyes 100. As illustrated in FIG. 1A, when the person gazes at the first object, the eyes 100 may have a first vergence angle α₁. When the person gazes at the second object, the eyes 100 may have a second vergence angle α₂. The pupils of the person's eyes 100 may be separated by an interpupillary distance (IPD).

Given the gaze directions and IPD (e.g., as determined by an eye-tracking system), the vergence angle may be calculated or estimated. Once the vergence angle is known, the fixation distance D1, D2 may be calculated using the following equation:

Fixation Distance=(IPD/2)/tan(vergence angle/2).

Accommodation is the process by which each eye changes in optical power, such as through altering the eye's lens shape, to maintain a clear image or focus on an object as the fixation distance varies. Both accommodation and vergence should be complete for the clearest view of an object or scene.

FIG. 1B illustrates a plot 102 of an example response time that a person's eyes verge and accommodate to focus on objects at a new distance. The solid line illustrates the response time of vergence, and the dotted line illustrates the response time of accommodation. As shown in the plot 102, when a person gazes at an object at a new distance, the eyes typically adjust to substantially the proper vergence and accommodation states within about one second (1000 ms). The eyes substantially maintain the vergence and accommodation states after about two to three seconds (2000-3000 ms) while continuing to gaze at the object if the object is stationary.

The present disclosure is generally directed to systems, devices, and methods for predicting a focal distance at which a user's eyes will fixate (e.g., a fixation distance). The systems may include an eye-tracking subsystem configured to track at least a gaze direction and movement velocity of the user's eyes and a fixation distance prediction subsystem configured to predict, based on information from the eye-tracking subsystem, the fixation distance at which the user's eyes will rest. The systems and methods of the present disclosure may reduce overall system latency of optical systems (e.g., head-mounted optical systems), such as by providing early information to operate a varifocal optical element and/or a near-eye display. Reducing the latency may improve a user's experience, such as in terms of comfort and image quality.

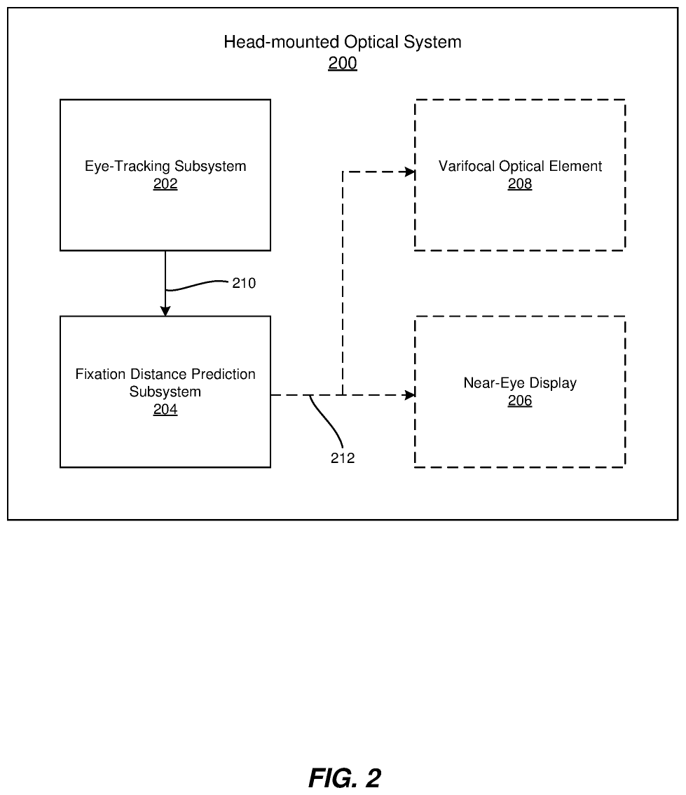

FIG. 2 is a block diagram illustrating a head-mounted optical system 200, according to at least one embodiment of the present disclosure. The head-mounted optical system 200 may include an eye-tracking subsystem 202 and a fixation distance prediction subsystem 204. In some embodiments, the head-mounted optical system 200 may include a near-eye display 206, such as in cases where the head-mounted optical system 200 is or includes a head-mounted display. In additional embodiments, the head-mounted optical system 200 may include a varifocal optical element 208. A varifocal optical element 208 may be included in a head-mounted display and/or in a system without a near-eye display 206. For example, the varifocal optical element 208 may be included in an eyeglass device configured to correct and/or supplement a user's vision.

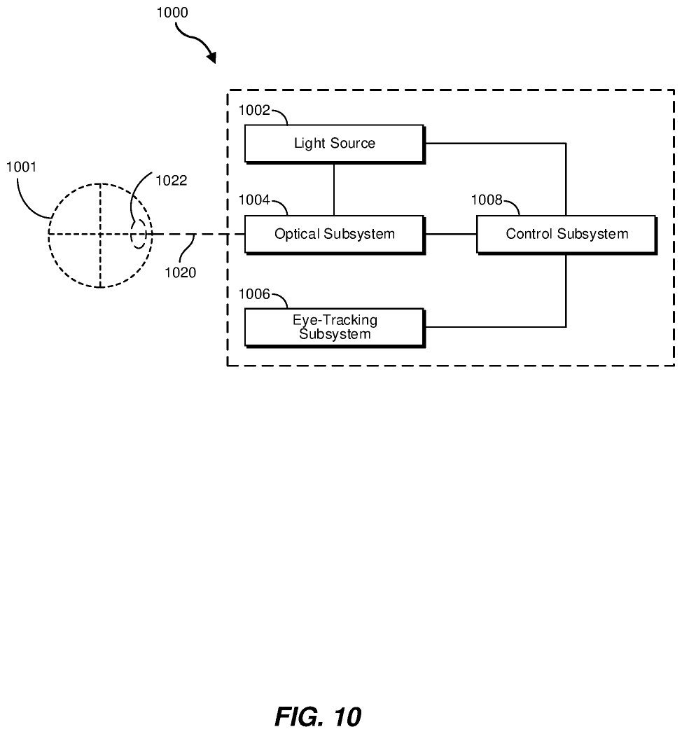

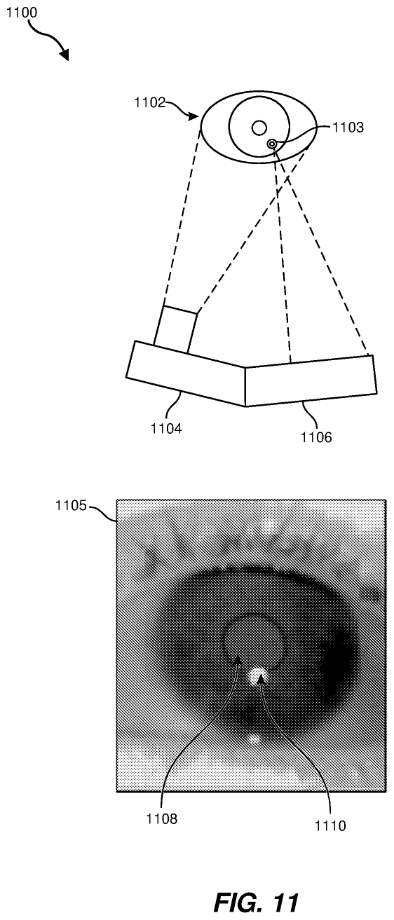

The eye-tracking subsystem 202 may be configured to track a gaze direction and/or movement speed of the user's eyes. The eye-tracking subsystem 202 may include a set of elements for tracking each of the user's eyes. The combination of the two sets of eye-tracking elements may be used to sense a vergence angle of the user's eyes to determine (e.g., estimate) a distance at which the user is gazing (also referred to as the gaze depth or fixation depth). In some examples, the eye-tracking subsystem 202 may include a substantially transparent lens element (e.g., a waveguide) that is configured for sensing a position of the pupil, cornea, retina, sclera, limbus, or other eye feature indicative of gaze direction. In some embodiments, the eye-tracking element may include a camera (e.g., a visible light camera and/or an infrared light camera) mounted to a frame of the head-mounted optical system 200 and directed toward the user's eye. Further descriptions of example eye-tracking elements and features thereof are presented below with reference to FIGS. 10 and 11.

The fixation distance prediction subsystem 204 may be configured to predict a fixation distance at which the user's eyes we become fixated prior to the user's eyes reaching a final fixation state associated with the predicted fixation distance. For example, the fixation distance prediction subsystem 204 may predict the fixation distance within about 600 ms prior to the user's eyes reaching the final fixation state. In additional examples, such as in the case of a shorter eye movement (e.g., to gaze at a new object that is relatively close in viewing angle to the eyes' current gaze), the fixation distance prediction subsystem 204 may predict the fixation distance within about 400 ms, within about 200 ms, within about 150 ms, within about 100 ms, within about 50 ms, or within about 20 ms prior to the user's eyes reaching the final fixation state. The fixation distance prediction subsystem 204 may include at least one processor that receives gaze information 210 indicative of the user's eye movement speed and gaze direction from the eye-tracking subsystem 202. The fixation distance prediction subsystem 204 may use the gaze information 210 to make a prediction 212 of the fixation distance.

In some embodiments, the fixation distance prediction subsystem 204 may employ a machine learning model to make the fixation distance prediction 212. For example, a machine learning module may be configured to train a machine learning model to facilitate and improve making the prediction 212. Machine learning models may use any suitable system, algorithm, and/or model that may build and/or implement a mathematical model based on sample data, known as training data, in order to make predictions or decisions without being explicitly programmed to do so. Examples of machine learning models may include, without limitation, artificial neural networks, decision trees, support vector machines, regression analysis, Bayesian networks, genetic algorithms, and so forth. Machine learning algorithms that may be used to construct, implement, and/or develop machine learning models may include, without limitation, supervised learning algorithms, unsupervised learning algorithms, self-learning algorithms, feature-learning algorithms, sparse dictionary learning algorithms, anomaly detection algorithms, robot learning algorithms, association rule learning methods, and the like.

In some examples, the machine learning module may train a machine learning model (e.g., a regression model) to determine the fixation distance prediction 212 by analyzing data from the eye-tracking subsystem 202. An initial training set of data supplied to the machine learning model may include data representative of eye position, eye velocity, and/or eye acceleration. The machine learning model may include an algorithm that updates the model based on new information, such as data generated by the eye-tracking subsystem 202 for a particular user, feedback from the user or a technician, and/or data from another sensor (e.g., an optical sensor, an ultrasound sensor, etc.). The machine learning model may be trained to ignore or discount noise data.

The fixation distance prediction 212 generated by the fixation distance prediction subsystem 204 may be used in a variety of ways. For example, in a head-mounted optical system 200 that includes a varifocal optical element 208, the fixation distance prediction 212 may be used to make an appropriate optical power change to the varifocal optical element 208. This may enable a pair of varifocal eyeglasses and/or a head-mounted display to make the optical power change prior to, at the same time as, or only slightly after the user's vergence and/or accommodation naturally reaches a steady fixation state associated the fixation distance prediction 212. Since the prediction 212 may be determined prior to the user's eyes reaching a final fixation state, the optical power change may be made earlier than would otherwise be possible if the optical power changes were made based on measuring an actual fixation distance.

If the head-mounted optical system 200 includes a near-eye display 206 the fixation distance prediction 212 may be used to alter displayed visual content, such as to provide focus cues to the user (e.g., blurred visual content at a different perceived depth than the fixation distance prediction 212 and/or at a periphery of the displayed visual content away from the fixation direction). These focus cues may be generated prior to, at the same time as, or only slightly after the user's vergence and/or accommodation naturally reaches a steady fixation state. Since the prediction 212 may be determined prior to the user's eyes reaching a final fixation state, the focus cues may be generated earlier than would otherwise be possible if the focus cues were rendered based on measuring an actual fixation distance.

The varifocal optical element 208, if present, may be any optical element that may change in at least one optical property, such as a focal distance/optical power. In some examples, the varifocal optical element 208 may be a substantially transparent element through which the user can gaze and that has at least one optical property (e.g., optical power, focal distance, astigmatism correction, etc.) that can be altered on-demand. For example, the varifocal optical element 208 may include a so-called “liquid lens,” a deformable mirror, an electrically driven varifocal lens, a mechanically adjustable lens, etc. In the case of a liquid lens, the liquid lens may include a substantially transparent support element, a substantially transparent deformable element coupled to the support element at least along a periphery of the deformable element, and a substantially transparent deformable medium disposed between the support element and the deformable element. Changing a shape of the deformable element (e.g., electrically and/or mechanically) and the deformable medium may change the at least one optical property (e.g., the focal distance) of the varifocal optical element 208.

The liquid lens may also include a varifocal actuator configured to, when actuated, change the shape and consequently the at least one optical property of the varifocal optical element 208. For example, the varifocal actuator may include a mechanical actuator, an electromechanical actuator, a piezoelectric actuator, an electrostatic actuator, or other actuator that may be configured and positioned to apply an actuating force to a peripheral region of the deformable element. The actuating force may cause the deformable medium to flow and the deformable element to alter its shape (e.g., to be more concave and/or more convex, to laterally shift an optical axis, etc.), resulting in a change in focal distance or other optical property.

In additional embodiments, the deformable element may include one or more electroactive materials (e.g., a substantially transparent electroactive polymer) that may change in shape upon application of a voltage thereto. In some examples, the electroactive material(s) may be actuated by at least one substantially transparent electrode coupled to the deformable element. The electrodes may include a substantially transparent conductive material and/or an opaque conductive material that is applied in a manner to be substantially transparent to the user. In this latter case, for example, the electrodes may include sufficiently thin lines of conductive material that may be straight and/or curved (e.g., squiggled) to result in the varifocal optical element 208 exhibiting substantial transparency from the perspective of the user.

In some examples, the terms “substantially” and “substantial,” in reference to a given parameter, property, or condition, may refer to a degree that one skilled in the art would understand that the given parameter, property, or condition is met with a small degree of variance, such as within acceptable manufacturing tolerances. For example, a parameter that is substantially met may be at least about 90% met, at least about 95% met, at least about 99% met, or fully met.

In additional examples, the varifocal optical element 208 may include a liquid crystal electroactive material that may be operable to change in focal distance upon application of a voltage thereto.

The head-mounted optical system 200 according to the present disclosure may reduce or eliminate latency in conventional optical systems, which may improve a user's experience in terms of comfort, immersiveness, and image quality.

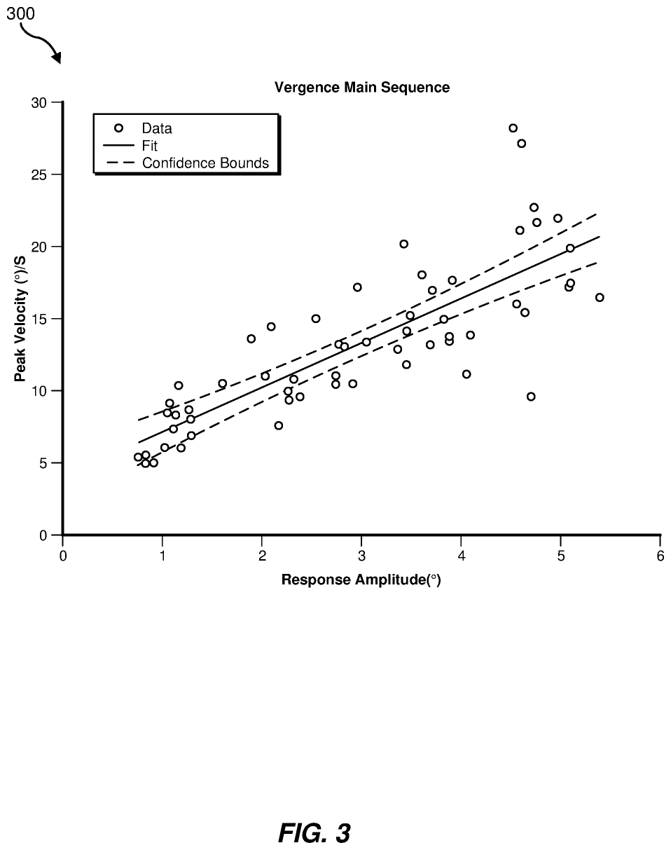

FIG. 3 is a plot 300 showing a relationship between peak velocity and response amplitude for a full convergence of eyes, according to at least one embodiment of the present disclosure. Vergence eye movements follow a predictable pattern; their peak velocity and final response amplitude are directly related. This relationship is referred to as the “main sequence.”

The plot 300 illustrates a vergence main sequence plot for convergence eye movements. Convergence refers to the eyes moving inward, such as to gaze at an object at a closer distance. For convergence, the relationship between peak velocity (in degrees per second) and final response amplitude (in degrees) is generally linear, with increasing dispersion of the confidence bounds with increasing response amplitudes and peak velocities. Divergence refers to the eyes moving outward, such as to gaze at an object at a farther distance. The vergence main sequence relationship is directionally unique, meaning that convergence eye may follow a different main sequence slope and intercept than divergence movements. Systems and devices of the present disclosure may be configured to account for such differences, such as by instituting a different algorithm for convergence and for divergence to improve the accuracy of the prediction model.

The vergence main sequence relationship for each individual user is also unique for both convergence and divergence responses. As noted above, systems of the present disclosure may employ and update a machine learning model to accurately predict a final fixation distance of a particular user. For example, a calibration procedure may set and/or improve an initial performance, and then the system may continuously or periodically update a modeled main sequence relationship during use. In some embodiments, a baseline prediction model for convergence and divergence may initially be used based on a set of training data, such as from population norms. This baseline prediction model may be updated and personalized as the user utilizes the system. In this case, the prediction may become more accurate over time as a user utilizes the system.

Using the relationship between peak velocity and response amplitude, systems and devices of the present disclosure can predict how large an on-going vergence eye movement amplitude will be before the eyes reach their final resting position. Vergence response peak velocities may occur between about 100 ms and about 600 ms before the vergence response is complete. This time depends on the final amplitude of vergence change. For example, larger response amplitudes tend to experience a greater time difference between peak velocity and response end compared to smaller response amplitudes. By estimating the final gaze-in-depth position (e.g., the vergence angle) using peak eye movement velocity, the system can direct a near-eye display and/or varifocal optical element to an appropriate focal distance before the eyes arrive, thus reducing an overall end-to-end latency.

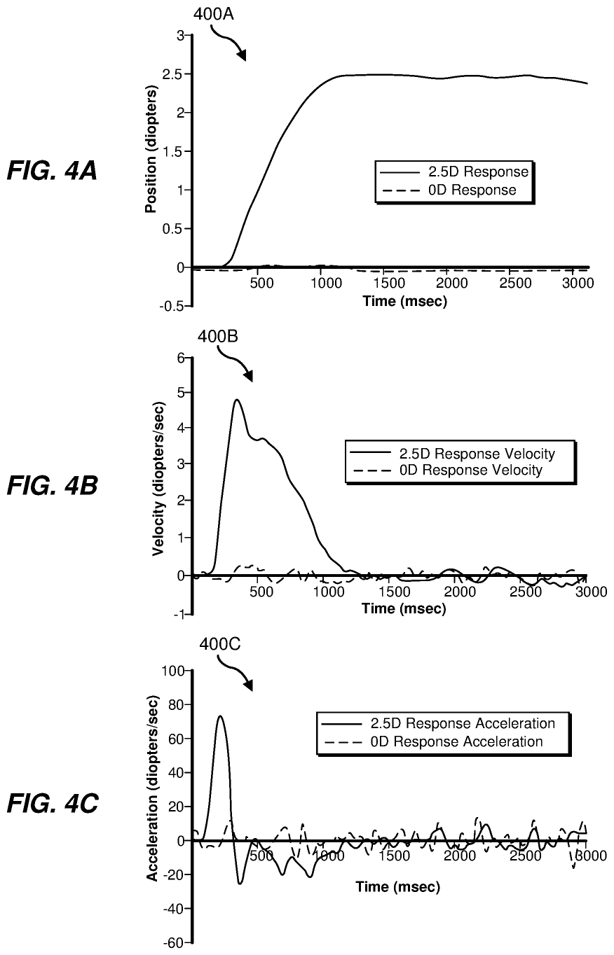

FIGS. 4A, 4B, and 4C include three respective plots 400A, 400B, and 400C, respectively showing position, velocity, and acceleration of eye movements during a convergence action, according to at least one embodiment of the present disclosure. In order to identify when the peak velocity is reached, the system can use vergence acceleration data, which may be calculated from an eye-tracking element as a second derivative of position. When acceleration crosses 0°/s², a peak in velocity is reached. The system can then use a customized or preloaded main sequence relationship to predict where the final vergence angle, and therefore fixation distance, will be. FIGS. 4A-4C illustrate how the vergence position, vergence velocity, and vergence acceleration are related.

In the position plot 400A of FIG. 4A, an example vergence position of eyes is shown over a period of time. The position is an angular position expressed in terms of diopters, which can be correlated to degrees of vergence angle. The vergence position transitions from 0 diopters to about 2.5 diopters and reaches a substantially steady state in about 1250 ms (about 1.25 seconds).

The velocity plot 400B of FIG. 4B shows an example vergence velocity of the eyes, aligned with the vergence position of position plot 400A. The vergence velocity is an angular velocity expressed in terms of diopters per second. The velocity increases quickly and peaks at about 5 diopters per second in about 400 ms (about 0.4 seconds), after which the velocity slows until the reaching substantially zero at the steady state, in about 1250 ms.

The acceleration plot 400C of FIG. 4C shows an example vergence acceleration of the eyes, aligned with the vergence position of position plot 400A and the vergence velocity of velocity plot 400B. The vergence position is an angular acceleration expressed in terms of diopters per second. The acceleration peaks in about 250 ms (about 0.25 seconds) and drops to cross zero at the same time that the velocity peaks, which is in about 400 ms. As the velocity slows, the acceleration is negative.

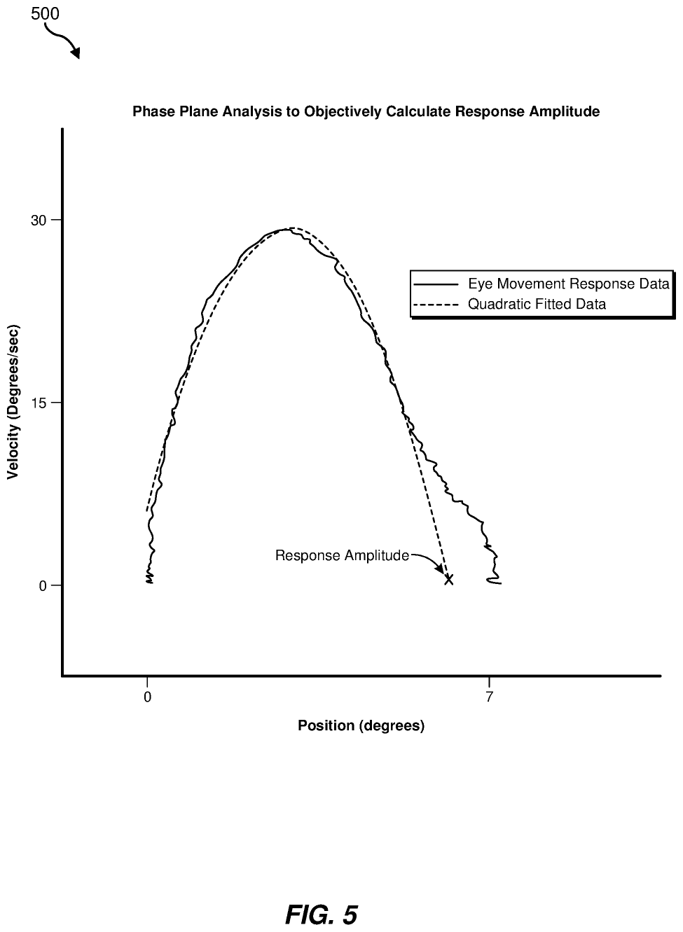

FIG. 5 is a plot 500 illustrating actual eye movement data (solid line) and an overlaid model (dashed line) for coarse alignment responses of eyes, according to at least one embodiment of the present disclosure. As can be seen in FIG. 3, the main sequence is generally linear for response amplitudes below about 4°. As response amplitudes increase beyond about 4°, the bounds of the regression (e.g., the confidence bounds) describing the main sequence increase. This means that the final response amplitude for larger responses may be less predictable if the same algorithm for smaller responses is used. This can impact the performance of the proposed methodology for larger changes in fixation distance.

Systems according to the present disclosure may improve the performance of this approach by leveraging how the brain controls a vergence response. Initially, a vergence eye movement is initiated by a burst of neural firing. This initial response will continue to completion, even if there is no visual input (e.g., the lights are turned off). When the gaze angle nears its final destination, the visual system in the brain switches to using visual information (e.g., blur and/or vergence feedback) to subtly adjust the vergence position to match the fixation distance of the desired object of interest. Thus, there is a coarse vergence adjustment (e.g., the initial response) and a fine vergence adjustment (e.g., the latter portions of the response) in the brain when eyes verge at a new fixation distance. The fine adjustment becomes a more significant portion of the total response as the amplitude increases. The fine adjustment is more variable, and thus less predictable, than the coarse adjustment when using the main sequence predictive approach.

The coarse adjustment is shown in FIG. 5 where the actual eye velocity data generally follows a quadratic fit to the data. The fine adjustment is shown in FIG. 5 at the right side of the plot 500 where the eye velocity data moves away from the quadratic fit to the data. The quadratic fit to the data (dashed line) in this figure shows what the vergence response amplitude would approximately be if there were no visual feedback and the response were driven by the coarse alignment response alone.

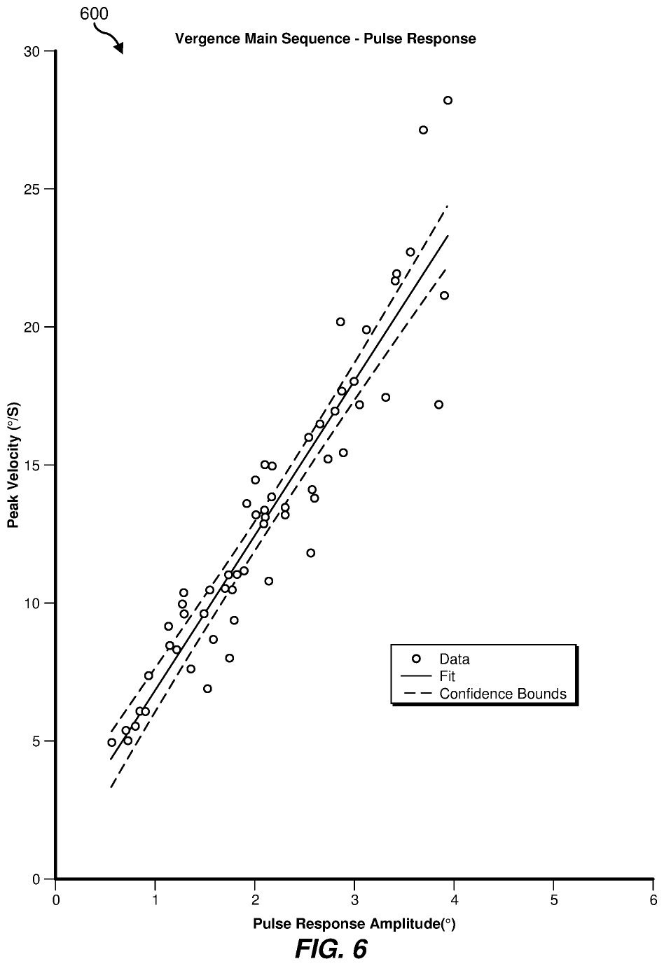

FIG. 6 is a plot 600 showing a relationship between peak velocity and response amplitude for coarse convergence of eyes, according to at least one embodiment of the present disclosure. The plot 600 illustrates only a predicted coarse response amplitude, in contrast to the plot 300 of FIG. 3 that illustrates a full response amplitude, including both coarse and fine adjustments. In comparing FIG. 6 with FIG. 3, the variance of the main sequence regressions is significantly reduced and much more linear when only the more predictable coarse response estimation is used. This technique can further hone the aforementioned predictive algorithm and/or machine learning models. As more gaze data and its dynamic properties are gathered through use, the systems of the present disclosure can compare the coarse response amplitude estimation with actual response amplitudes in order to further calibrate and increase accuracy of the prediction model.

Another challenge to this methodology will be encountered when multiple vergence responses are produced in sequence before the eyes reach a steady state position. In such cases, taking only the first peak in the velocity signal may result in inaccuracies in the predicted final response amplitude. To counteract such effects, the system can identify all peaks in the velocity signal (e.g., when the acceleration values cross zero) and may continuously sum the expected amplitudes to improve the prediction of the final fixation distance.

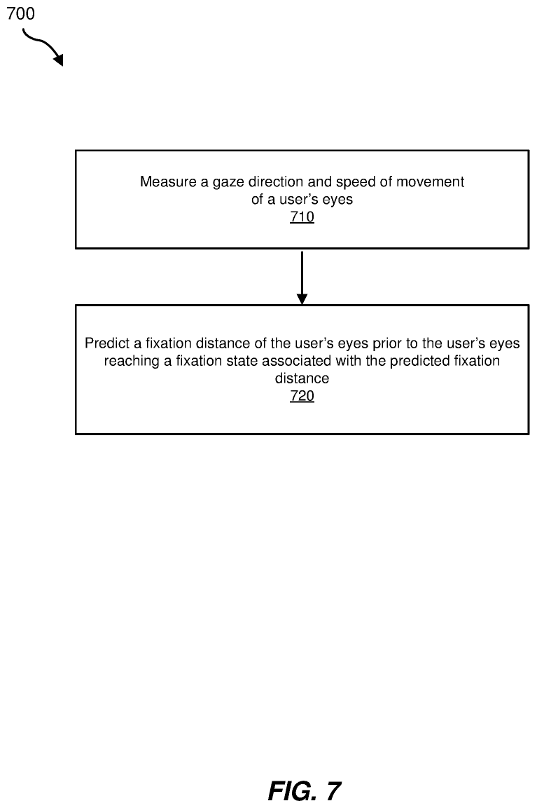

FIG. 7 is a flow diagram illustrating a method 700 of operating a head-mounted optical device, according to at least one embodiment of the present disclosure. At operation 710, a gaze direction and speed of movement of a user's eyes may be measured, such as with an eye-tracking element. Operation 710 may be performed in a variety of ways. For example, the eye-tracking element may function as described with reference to FIGS. 2, 10, and/or 11.

At operation 720, a fixation distance of the user's eyes may be predicted prior to the user's eyes reaching a final fixation state associated with the predicted fixation distance. This prediction may be performed within about 600 ms prior to the final fixation state. Operation 710 may be performed in a variety of ways. For example, the prediction may be made by at least one processor, based on the measured gaze direction and speed of movement of the user's eyes. The peak velocity of the eyes may be determined, which may be used to predict when the eyes will reach a steady state. In some embodiments, a machine learning model may be employed to make the prediction.

The method 700 may also include additional operations. For example, at least a focal distance of a varifocal optical element may be altered based on (e.g., to substantially match) the predicted fixation distance of the user's eyes. Visual content may be presented to the user's eyes with a near-eye display (e.g., of a head-mounted display), and portions of the visual content may be blurred at a different perceived depth than the predicted fixation distance. In some examples, the blurring may be accomplished by only fully rendering visual content within the user's field of view, which may in turn reduce computation requirements (and, therefore, a size and weight) of the overall system. This blurring may be completed prior to the user's eyes verging to reach the fixation distance.

Accordingly, the present disclosure includes systems, devices, and methods that may be employed to predict a user's eye fixation distance prior to the eyes reaching a steady state in fixation. The disclosed concepts may reduce a system latency for head-mounted optical systems, such as head-mounted displays that render focal/blur cues for visual content presented to the user and/or varifocal optical elements that may change in focal distance (e.g., optical power).

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

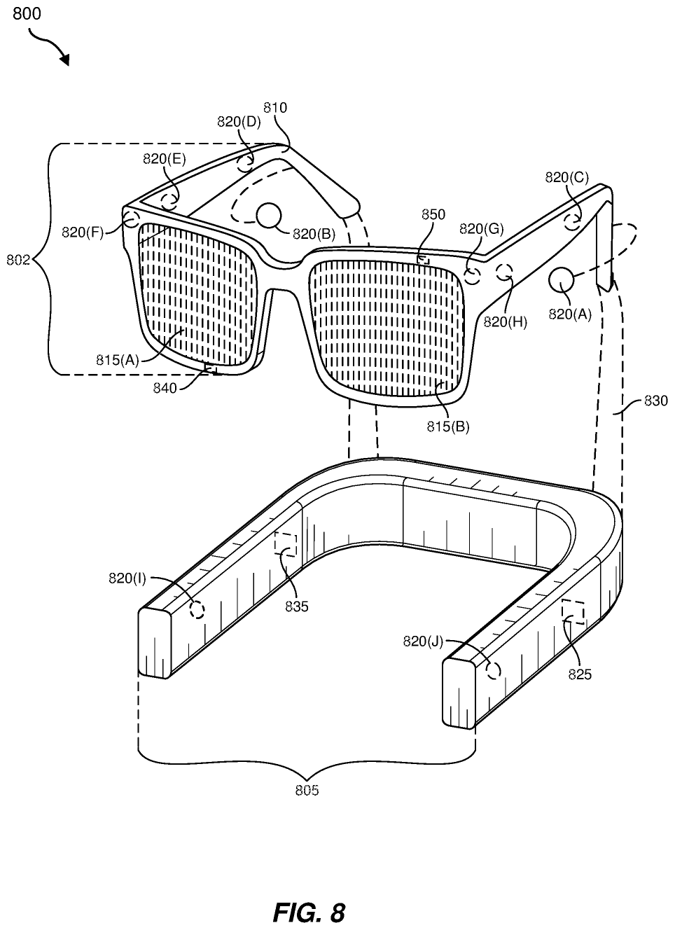

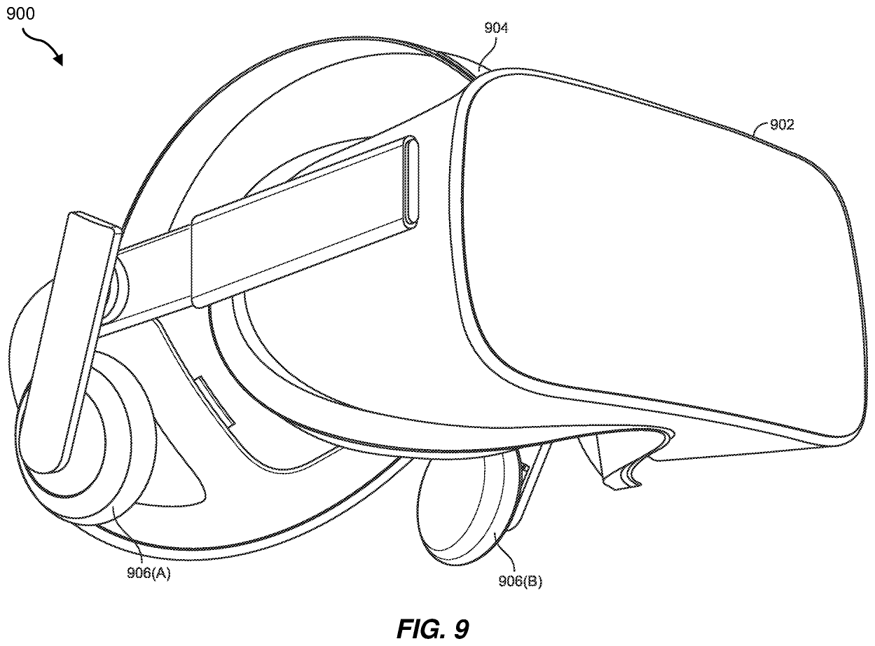

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 800 in FIG. 8) or that visually immerses a user in an artificial reality (such as, e.g., virtual-reality system 900 in FIG. 9). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 8, augmented-reality system 800 may include an eyewear device 802 with a frame 810 configured to hold a left display device 815(A) and a right display device 815(B) in front of a user's eyes. Display devices 815(A) and 815(B) may act together or independently to present an image or series of images to a user. While augmented-reality system 800 includes two displays, embodiments of this disclosure may be implemented in augmented-reality systems with a single NED or more than two NEDs.

In some embodiments, augmented-reality system 800 may include one or more sensors, such as sensor 840. Sensor 840 may generate measurement signals in response to motion of augmented-reality system 800 and may be located on substantially any portion of frame 810. Sensor 840 may represent one or more of a variety of different sensing mechanisms, such as a position sensor, an inertial measurement unit (IMU), a depth camera assembly, a structured light emitter and/or detector, or any combination thereof. In some embodiments, augmented-reality system 800 may or may not include sensor 840 or may include more than one sensor. In embodiments in which sensor 840 includes an IMU, the IMU may generate calibration data based on measurement signals from sensor 840. Examples of sensor 840 may include, without limitation, accelerometers, gyroscopes, magnetometers, other suitable types of sensors that detect motion, sensors used for error correction of the IMU, or some combination thereof.

In some examples, augmented-reality system 800 may also include a microphone array with a plurality of acoustic transducers 820(A)-820(J), referred to collectively as acoustic transducers 820. Acoustic transducers 820 may represent transducers that detect air pressure variations induced by sound waves. Each acoustic transducer 820 may be configured to detect sound and convert the detected sound into an electronic format (e.g., an analog or digital format). The microphone array in FIG. 8 may include, for example, ten acoustic transducers: 820(A) and 820(B), which may be designed to be placed inside a corresponding ear of the user, acoustic transducers 820(C), 820(D), 820(E), 820(F), 820(G), and 820(H), which may be positioned at various locations on frame 810, and/or acoustic transducers 820(1) and 820(J), which may be positioned on a corresponding neckband 805.

In some embodiments, one or more of acoustic transducers 820(A)-(J) may be used as output transducers (e.g., speakers). For example, acoustic transducers 820(A) and/or 820(B) may be earbuds or any other suitable type of headphone or speaker.

The configuration of acoustic transducers 820 of the microphone array may vary. While augmented-reality system 800 is shown in FIG. 8 as having ten acoustic transducers 820, the number of acoustic transducers 820 may be greater or less than ten. In some embodiments, using higher numbers of acoustic transducers 820 may increase the amount of audio information collected and/or the sensitivity and accuracy of the audio information. In contrast, using a lower number of acoustic transducers 820 may decrease the computing power required by an associated controller 850 to process the collected audio information. In addition, the position of each acoustic transducer 820 of the microphone array may vary. For example, the position of an acoustic transducer 820 may include a defined position on the user, a defined coordinate on frame 810, an orientation associated with each acoustic transducer 820, or some combination thereof.

Acoustic transducers 820(A) and 820(B) may be positioned on different parts of the user's ear, such as behind the pinna, behind the tragus, and/or within the auricle or fossa. Or, there may be additional acoustic transducers 820 on or surrounding the ear in addition to acoustic transducers 820 inside the ear canal. Having an acoustic transducer 820 positioned next to an ear canal of a user may enable the microphone array to collect information on how sounds arrive at the ear canal. By positioning at least two of acoustic transducers 820 on either side of a user's head (e.g., as binaural microphones), augmented-reality device 800 may simulate binaural hearing and capture a 3D stereo sound field around about a user's head. In some embodiments, acoustic transducers 820(A) and 820(B) may be connected to augmented-reality system 800 via a wired connection 830, and in other embodiments acoustic transducers 820(A) and 820(B) may be connected to augmented-reality system 800 via a wireless connection (e.g., a BLUETOOTH connection). In still other embodiments, acoustic transducers 820(A) and 820(B) may not be used at all in conjunction with augmented-reality system 800.

Acoustic transducers 820 on frame 810 may be positioned in a variety of different ways, including along the length of the temples, across the bridge, above or below display devices 815(A) and 815(B), or some combination thereof. Acoustic transducers 820 may also be oriented such that the microphone array is able to detect sounds in a wide range of directions surrounding the user wearing the augmented-reality system 800. In some embodiments, an optimization process may be performed during manufacturing of augmented-reality system 800 to determine relative positioning of each acoustic transducer 820 in the microphone array.

In some examples, augmented-reality system 800 may include or be connected to an external device (e.g., a paired device), such as neckband 805. Neckband 805 generally represents any type or form of paired device. Thus, the following discussion of neckband 805 may also apply to various other paired devices, such as charging cases, smart watches, smart phones, wrist bands, other wearable devices, hand-held controllers, tablet computers, laptop computers, other external compute devices, etc.

As shown, neckband 805 may be coupled to eyewear device 802 via one or more connectors. The connectors may be wired or wireless and may include electrical and/or non-electrical (e.g., structural) components. In some cases, eyewear device 802 and neckband 805 may operate independently without any wired or wireless connection between them. While FIG. 8 illustrates the components of eyewear device 802 and neckband 805 in example locations on eyewear device 802 and neckband 805, the components may be located elsewhere and/or distributed differently on eyewear device 802 and/or neckband 805. In some embodiments, the components of eyewear device 802 and neckband 805 may be located on one or more additional peripheral devices paired with eyewear device 802, neckband 805, or some combination thereof.

Pairing external devices, such as neckband 805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 800 may be provided by a paired device or shared between a paired device and an eyewear device, thus reducing the weight, heat profile, and form factor of the eyewear device overall while still retaining desired functionality. For example, neckband 805 may allow components that would otherwise be included on an eyewear device to be included in neckband 805 since users may tolerate a heavier weight load on their shoulders than they would tolerate on their heads. Neckband 805 may also have a larger surface area over which to diffuse and disperse heat to the ambient environment. Thus, neckband 805 may allow for greater battery and computation capacity than might otherwise have been possible on a stand-alone eyewear device. Since weight carried in neckband 805 may be less invasive to a user than weight carried in eyewear device 802, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 805 may be communicatively coupled with eyewear device 802 and/or to other devices. These other devices may provide certain functions (e.g., tracking, localizing, depth mapping, processing, storage, etc.) to augmented-reality system 800. In the embodiment of FIG. 8, neckband 805 may include two acoustic transducers (e.g., 820(I) and 820(J)) that are part of the microphone array (or potentially form their own microphone subarray). Neckband 805 may also include a controller 825 and a power source 835.

Acoustic transducers 820(I) and 820(J) of neckband 805 may be configured to detect sound and convert the detected sound into an electronic format (analog or digital). In the embodiment of FIG. 8, acoustic transducers 820(I) and 820(J) may be positioned on neckband 805, thereby increasing the distance between the neckband acoustic transducers 820(I) and 820(J) and other acoustic transducers 820 positioned on eyewear device 802. In some cases, increasing the distance between acoustic transducers 820 of the microphone array may improve the accuracy of beamforming performed via the microphone array. For example, if a sound is detected by acoustic transducers 820(C) and 820(D) and the distance between acoustic transducers 820(C) and 820(D) is greater than, e.g., the distance between acoustic transducers 820(D) and 820(E), the determined source location of the detected sound may be more accurate than if the sound had been detected by acoustic transducers 820(D) and 820(E).

Controller 825 of neckband 805 may process information generated by the sensors on neckband 805 and/or augmented-reality system 800. For example, controller 825 may process information from the microphone array that describes sounds detected by the microphone array. For each detected sound, controller 825 may perform a direction-of-arrival (DOA) estimation to estimate a direction from which the detected sound arrived at the microphone array. As the microphone array detects sounds, controller 825 may populate an audio data set with the information. In embodiments in which augmented-reality system 800 includes an inertial measurement unit, controller 825 may compute all inertial and spatial calculations from the IMU located on eyewear device 802. A connector may convey information between augmented-reality system 800 and neckband 805 and between augmented-reality system 800 and controller 825. The information may be in the form of optical data, electrical data, wireless data, or any other transmittable data form. Moving the processing of information generated by augmented-reality system 800 to neckband 805 may reduce weight and heat in eyewear device 802, making it more comfortable to the user.

Power source 835 in neckband 805 may provide power to eyewear device 802 and/or to neckband 805. Power source 835 may include, without limitation, lithium ion batteries, lithium-polymer batteries, primary lithium batteries, alkaline batteries, or any other form of power storage. In some cases, power source 835 may be a wired power source. Including power source 835 on neckband 805 instead of on eyewear device 802 may help better distribute the weight and heat generated by power source 835.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 900 in FIG. 9, that mostly or completely covers a user's field of view. Virtual-reality system 900 may include a front rigid body 902 and a band 904 shaped to fit around a user's head. Virtual-reality system 900 may also include output audio transducers 906(A) and 906(B). Furthermore, while not shown in FIG. 9, front rigid body 902 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 800 and/or virtual-reality system 900 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 800 and/or virtual-reality system 900 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 800 and/or virtual-reality system 900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

FIG. 10 is an illustration of an exemplary system 1000 that incorporates an eye-tracking subsystem capable of tracking a user's eye(s). As depicted in FIG. 10, system 1000 may include a light source 1002, an optical subsystem 1004, an eye-tracking subsystem 1006, and/or a control subsystem 1008. In some examples, light source 1002 may generate light for an image (e.g., to be presented to an eye 1001 of the viewer). Light source 1002 may represent any of a variety of suitable devices. For example, light source 1002 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 1004 may receive the light generated by light source 1002 and generate, based on the received light, converging light 1020 that includes the image. In some examples, optical subsystem 1004 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 1020. Further, various mechanical couplings may serve to maintain the relative spacing and/or the orientation of the optical components in any suitable combination.

In one embodiment, eye-tracking subsystem 1006 may generate tracking information indicating a gaze angle of an eye 1001 of the viewer. In this embodiment, control subsystem 1008 may control aspects of optical subsystem 1004 (e.g., the angle of incidence of converging light 1020) based at least in part on this tracking information. Additionally, in some examples, control subsystem 1008 may store and utilize historical tracking information (e.g., a history of the tracking information over a given duration, such as the previous second or fraction thereof) to anticipate the gaze angle of eye 1001 (e.g., an angle between the visual axis and the anatomical axis of eye 1001). In some embodiments, eye-tracking subsystem 1006 may detect radiation emanating from some portion of eye 1001 (e.g., the cornea, the iris, the pupil, or the like) to determine the current gaze angle of eye 1001. In other examples, eye-tracking subsystem 1006 may employ a wavefront sensor to track the current location of the pupil.

Any number of techniques can be used to track eye 1001. Some techniques may involve illuminating eye 1001 with infrared light and measuring reflections with at least one optical sensor that is tuned to be sensitive to the infrared light. Information about how the infrared light is reflected from eye 1001 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 1006 may be digitized (i.e., converted to an electronic signal). Further, the sensor may transmit a digital representation of this electronic signal to one or more processors (for example, processors associated with a device including eye-tracking subsystem 1006). Eye-tracking subsystem 1006 may include any of a variety of sensors in a variety of different configurations. For example, eye-tracking subsystem 1006 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 1006 to track the movement of eye 1001. In another example, these processors may track the movements of eye 1001 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 1006 may be programmed to use an output of the sensor(s) to track movement of eye 1001. In some embodiments, eye-tracking subsystem 1006 may analyze the digital representation generated by the sensors to extract eye rotation information from changes in reflections. In one embodiment, eye-tracking subsystem 1006 may use corneal reflections or glints (also known as Purkinje images) and/or the center of the eye's pupil 1022 as features to track over time.

In some embodiments, eye-tracking subsystem 1006 may use the center of the eye's pupil 1022 and infrared or near-infrared, non-collimated light to create corneal reflections. In these embodiments, eye-tracking subsystem 1006 may use the vector between the center of the eye's pupil 1022 and the corneal reflections to compute the gaze direction of eye 1001. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 1006 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 1001 may act as a retroreflector as the light reflects off the retina, thereby creating a bright pupil effect similar to a red-eye effect in photography. If the illumination source is offset from the optical path, then the eye's pupil 1022 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 1008 may control light source 1002 and/or optical subsystem 1004 to reduce optical aberrations (e.g., chromatic aberrations and/or monochromatic aberrations) of the image that may be caused by or influenced by eye 1001. In some examples, as mentioned above, control subsystem 1008 may use the tracking information from eye-tracking subsystem 1006 to perform such control. For example, in controlling light source 1002, control subsystem 1008 may alter the light generated by light source 1002 (e.g., by way of image rendering) to modify (e.g., pre-distort) the image so that the aberration of the image caused by eye 1001 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

FIG. 11 is a more detailed illustration of various aspects of the eye-tracking subsystem illustrated in FIG. 10. As shown in this figure, an eye-tracking subsystem 1100 may include at least one source 1104 and at least one sensor 1106. Source 1104 generally represents any type or form of element capable of emitting radiation. In one example, source 1104 may generate visible, infrared, and/or near-infrared radiation. In some examples, source 1104 may radiate non-collimated infrared and/or near-infrared portions of the electromagnetic spectrum towards an eye 1102 of a user. Source 1104 may utilize a variety of sampling rates and speeds. For example, the disclosed systems may use sources with higher sampling rates in order to capture fixational eye movements of a user's eye 1102 and/or to correctly measure saccade dynamics of the user's eye 1102. As noted above, any type or form of eye-tracking technique may be used to track the user's eye 1102, including optical-based eye-tracking techniques, ultrasound-based eye-tracking techniques, etc.

Sensor 1106 generally represents any type or form of element capable of detecting radiation, such as radiation reflected off the user's eye 1102. Examples of sensor 1106 include, without limitation, a charge coupled device (CCD), a photodiode array, a complementary metal-oxide-semiconductor (CMOS) based sensor device, and/or the like. In one example, sensor 1106 may represent a sensor having predetermined parameters, including, but not limited to, a dynamic resolution range, linearity, and/or other characteristic selected and/or designed specifically for eye tracking.

As detailed above, eye-tracking subsystem 1100 may generate one or more glints. As detailed above, a glint 1103 may represent reflections of radiation (e.g., infrared radiation from an infrared source, such as source 1104) from the structure of the user's eye. In various embodiments, glint 1103 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 11 shows an example image 1105 captured by an eye-tracking subsystem, such as eye-tracking subsystem 1100. In this example, image 1105 may include both the user's pupil 1108 and a glint 1110 near the same. In some examples, pupil 1108 and/or glint 1110 may be identified using an artificial-intelligence-based algorithm, such as a computer-vision-based algorithm. In one embodiment, image 1105 may represent a single frame in a series of frames that may be analyzed continuously in order to track the eye 1102 of the user. Further, pupil 1108 and/or glint 1110 may be tracked over a period of time to determine a user's gaze.

In one example, eye-tracking subsystem 1100 may be configured to identify and measure the inter-pupillary distance (IPD) of a user. In some embodiments, eye-tracking subsystem 1100 may measure and/or calculate the IPD of the user while the user is wearing the artificial reality system. In these embodiments, eye-tracking subsystem 1100 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 1000 and/or eye-tracking subsystem 1100 may be incorporated into augmented-reality system 800 in FIG. 8 and/or virtual-reality system 900 in

FIG. 9 to enable these systems to perform various eye-tracking tasks (including one or more of the eye-tracking operations described herein).

The following example embodiments are also included in the present disclosure:

Example 1: A head-mounted optical system, which may include: an eye-tracking subsystem configured to determine at least a gaze direction of a user's eyes and an eye movement speed of the user's eyes; and a fixation distance prediction subsystem configured to predict, based on the eye movement speed and gaze direction of the user's eyes, a fixation distance at which the user's eyes will become fixated prior to the user's eyes reaching a fixation state associated with the predicted fixation distance.

Example 2: The head-mounted optical system of Example 1, further including a varifocal optical element mounted to be in a position in front of the user's eye when the head-mounted optical system is worn by the user, the varifocal optical element configured to change, based on information from the eye-tracking subsystem and fixation distance prediction subsystem, in at least one optical property including a focal distance.

Example 3: The head-mounted optical system of Example 2, wherein the varifocal optical element includes: a substantially transparent support element; a substantially transparent deformable element coupled to the support element at least along a periphery of the deformable element; and a substantially transparent deformable medium disposed between the support element and the deformable element.

Example 4: The head-mounted optical system of Example 3, wherein the varifocal optical element further includes a varifocal actuator configured to, when actuated, change the at least one optical property of the varifocal optical element.

Example 5: The head-mounted optical system of Example 4, wherein the varifocal actuator includes at least one substantially transparent electrode coupled to the deformable element.

Example 6: The head-mounted optical system of any of Examples 2 through 5, wherein the varifocal optical element includes a liquid crystal element configured to, when activated, change the at least one optical property of the varifocal optical element.

Example 7: The head-mounted optical system of any of Examples 1 through 6, further including a near-eye display configured to display visual content to the user.

Example 8: The head-mounted optical system of Example 7, wherein the near-eye display is operable to fully render only portions of the visual content at a perceived depth at which the user's eyes fixate.

Example 9: The head-mounted optical system of any of Examples 1 through 8, wherein the fixation distance prediction subsystem is configured to predict the fixation distance at which the user's eyes will become fixated within 600 ms prior to the user's eyes reaching the fixation state associated with the predicted fixation distance.

Example 10: A method of operating a head-mounted optical device, which method may include: measuring, with an eye-tracking element, a gaze direction and speed of movement of a user's eyes; and predicting, with at least one processor and based on the measured gaze direction and speed of movement of the user's eyes, a fixation distance of the user's eyes prior to the user's eyes reaching a fixation state associated with the predicted fixation distance.

Example 11: The method of Example 10, further including: altering, with a varifocal optical element, at least a focal distance of the varifocal optical element based on the predicted fixation distance of the user's eyes.

Example 12: The method of Example 10 or Example 11, further including: presenting visual content to the user's eyes with a near-eye display; and fully rendering only portions of the visual content that are at the predicted fixation distance of the user's eye.

Example 13: The method of Example 12, wherein the full rendering of only portions of the visual content is completed prior to the user's eyes verging to reach the fixation distance.

Example 14: The method of any of Examples 10 through 13, wherein: measuring the speed of movement of the user's eyes includes measuring a maximum speed of the user's eyes; and predicting the fixation distance is based at least in part on the maximum speed of the user's eyes.

Example 15: The method of any of Examples 10 through 14, wherein the prediction of the fixation distance at which the user's eyes will become fixated is completed within 600 ms prior to the user's eyes reaching the fixation state associated with the predicted fixation distance.

Example 16: A non-transitory computer-readable medium including one or more computer-executable instructions that, when executed by at least one processor of a computing device, cause the computing device to: measure, with an eye-tracking element, a gaze direction and speed of movement of a user's eyes; and predict, based on the measured gaze direction and speed of movement of the user's eyes, a fixation distance of the user's eyes prior to the user's eyes reaching a fixation state associated with the predicted fixation distance.

Example 17: The non-transitory computer-readable medium of Example 16, wherein the one or more computer-executable instructions further cause the computing device to alter, with a varifocal optical element, at least a focal distance of the varifocal optical element based on the predicted fixation distance of the user's eyes.

Example 18: The non-transitory computer-readable medium of Example 16 or Example 17, wherein the one or more computer-executable instructions further cause the computing device to: present visual content to the user's eyes with a near-eye display; and fully render only portions of the visual content that are at the predicted fixation distance of the user's eyes.

Example 19: The non-transitory computer-readable medium of Example 18, wherein the one or more computer-executable instructions further cause the computing device to complete full rendering of only the portions of the content prior to the user's eyes verging to reach the fixation distance.

Example 20: The non-transitory computer-readable medium of any of Examples 16 through 19, wherein the one or more computer-executable instructions further cause the computing device to complete the prediction of the fixation distance at which the user's eyes will become fixated within 600 ms prior to the user's eyes reaching the fixation state associated with the predicted fixation distance.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive measurement data to be transformed, transform the measurement data, output a result of the transformation to predict a fixation distance of a user's eye, use the result of the transformation to alter focus cues in visual content displayed to a user, and store the result of the transformation to update a machine learning model. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A head-mounted optical system, comprising:
an eye-tracking subsystem configured to determine at least a gaze direction of a user's eyes and an eye movement speed of the user's eyes; and
a fixation distance prediction subsystem configured to predict, based on the eye movement speed and gaze direction of the user's eyes, a fixation distance at which the user's eyes will become fixated prior to the user's eyes reaching a fixation state associated with the predicted fixation distance.

2. The head-mounted optical system of claim 1, further comprising a varifocal optical element mounted to be in a position in front of the user's eye when the head-mounted optical system is worn by the user, the varifocal optical element configured to change, based on information from the eye-tracking subsystem and fixation distance prediction subsystem, in at least one optical property including a focal distance.

3. The head-mounted optical system of claim 2, wherein the varifocal optical element comprises:
a substantially transparent support element;
a substantially transparent deformable element coupled to the support element at least along a periphery of the deformable element; and
a substantially transparent deformable medium disposed between the support element and the deformable element.

4. The head-mounted optical system of claim 3, wherein the varifocal optical element further comprises a varifocal actuator configured to, when actuated, change the at least one optical property of the varifocal optical element.

5. The head-mounted optical system of claim 4, wherein the varifocal actuator comprises at least one substantially transparent electrode coupled to the deformable element.

6. The head-mounted optical system of claim 2, wherein the varifocal optical element comprises a liquid crystal element configured to, when activated, change the at least one optical property of the varifocal optical element.

7. The head-mounted optical system of claim 1, further comprising a near-eye display configured to display visual content to the user.

8. The head-mounted optical system of claim 7, wherein the near-eye display is operable to fully render only portions of the visual content at a perceived depth at which the user's eyes fixate.

9. The head-mounted optical system of claim 1, wherein the fixation distance prediction subsystem is configured to predict the fixation distance at which the user's eyes will become fixated within 600 ms prior to the user's eyes reaching the fixation state associated with the predicted fixation distance.

10. A computer-implemented method of operating a head-mounted optical device, the method comprising:
measuring, with an eye-tracking element, a gaze direction and speed of movement of a user's eyes; and
predicting, with at least one processor and based on the measured gaze direction and speed of movement of the user's eyes, a fixation distance of the user's eyes prior to the user's eyes reaching a fixation state associated with the predicted fixation distance.

11. The method of claim 10, further comprising:
altering, with a varifocal optical element, at least a focal distance of the varifocal optical element based on the predicted fixation distance of the user's eyes.

12. The method of claim 10, further comprising:
presenting visual content to the user's eyes with a near-eye display; and
fully rendering only portions of the visual content that are at the predicted fixation distance of the user's eyes.

13. The method of claim 12, wherein the full rendering of only the portions of the visual content is completed prior to the user's eyes verging to reach the fixation distance.

14. The method of claim 10, wherein:
measuring the speed of movement of the user's eyes comprises measuring a maximum speed of the user's eyes; and
predicting the fixation distance is based at least in part on the maximum speed of the user's eyes.

15. The method of claim 10, wherein the prediction of the fixation distance at which the user's eyes will become fixated is completed within 600 ms prior to the user's eyes reaching the fixation state associated with the predicted fixation distance.

16. A non-transitory computer-readable medium comprising one or more computer-executable instructions that, when executed by at least one processor of a computing device, cause the computing device to:
measure, with an eye-tracking element, a gaze direction and speed of movement of a user's eyes; and
predict, based on the measured gaze direction and speed of movement of the user's eyes, a fixation distance of the user's eyes prior to the user's eyes reaching a fixation state associated with the predicted fixation distance.

17. The non-transitory computer-readable medium of claim 16, wherein the one or more computer-executable instructions further cause the computing device to alter, with a varifocal optical element, at least a focal distance of the varifocal optical element based on the predicted fixation distance of the user's eyes.

18. The non-transitory computer-readable medium of claim 16, wherein the one or more computer-executable instructions further cause the computing device to:
present visual content to the user's eyes with a near-eye display; and
fully render only portions of the visual content that are at the predicted fixation distance of the user's eyes.

19. The non-transitory computer-readable medium of claim 18, wherein the one or more computer-executable instructions further cause the computing device to complete full rendering of only the portions of the content prior to the user's eyes verging to reach the fixation distance.

20. The non-transitory computer-readable medium of claim 16, wherein the one or more computer-executable instructions further cause the computing device to complete the prediction of the fixation distance at which the user's eyes will become fixated within 600 ms prior to the user's eyes reaching the fixation state associated with the predicted fixation distance.
